(19) United States
(12) Patent Application Publication
(10) Pub. No.: US 2005/0189282 A1
(43) Pub. Date: Sep. 1, 2005

(54) Tri-axial membrane filtration device and process

(76) Inventor: Pierre Lucien Cote, Dundas (CA)

Correspondence Address: BERESKIN AND PARR, 40 KING STREET WEST, BOX 401, TORONTO, ON, M5H 3Y2, CA

(21) Appl. No.: 11/059,693

(22) Filed: Feb. 17, 2005

Related U.S. Application Data
(60) Provisional application No. 60/547,429, filed on Feb. 26, 2004.

(51) Int. Cl. B01D 65/02

(52) U.S. Cl. 210/321.69; 210/321.8; 210/321.89

(57) ABSTRACT

A filtration module has elements having hollow fiber membranes oriented horizontally between vertically extending headers. Shrouds extending between the headers on either side of the elements providing vertically extending gaps between adjacent elements in the module. The shrouds permit water to flow through them but constrain the membranes and may discourage scouring bubbles from leaving the elements.

This is an application claiming the benefit under 35 USC 119(e) of U.S. Ser. No. 60/547,429 filed Feb. 26, 2004. U.S. Ser. No. 60/547,429 is incorporated herein, in its entirety, by this reference to it.

### FIELD OF THE INVENTION

This invention relates to membrane separation devices and processes as in, for example, water filtration using membranes.

### BACKGROUND OF THE INVENTION

A batch filtration process has a repeated cycle of concentration, or permeation, and deconcentration steps. During the concentration step, permeate is withdrawn from a fresh batch of feed water initially having a low concentration of solids. As the permeate is withdrawn, fresh water is introduced to replace the water withdrawn as permeate. During this step, which may last from 10 minutes to 4 hours, solids are rejected by the membranes and do not flow out of the tank with the permeate. As a result, the concentration of solids in the tank increases, for example to between 2 and 100, more typically 5 to 50, times the initial concentration. The process then proceeds to the deconcentration step. In the deconcentration step, which is typically between 1/50 and ⅕ the duration of the concentration step, a large quantity of solids are rapidly removed from the tank to return the solids concentration back to the initial concentration. This is most commonly done by draining the tank and refilling it with new feed water. To help move solids away from the membranes themselves, air scouring and backwashing are often used before or during the deconcentration step. This type of process was initially practiced only in small or pressurized systems, but has since been used in large open tank systems such as the ones described below.

International Publication No. WO98/28066 describes a membrane filtration module having vertical hollow fiber membranes between a pair of circular headers. Scouring air is provided through holes in the bottom header. Permeate is withdrawn from the top header. In a batch process, a tank holding the module is drained periodically and re-filled with new feed water.

U.S. Pat. No. 6,303,035 describes a module of horizontal hollow fiber membranes used in a batch process. Scouring air is provided by an aerator below the module and the tank is drained and re-filled between batches.

U.S. Pat. No. 6,375,848 describes a batch process using a module of hollow fiber membranes. A tank holding the membranes is deconcentrated between batches by opening a drain while simultaneously increasing the rate of feed flow such that the membranes remain under water during the deconcentration.

International Publication No. WO01/36074 describes filtration elements of horizontal hollow fibers between vertical headers. Solid side plates extending between the headers define a vertical flow channel through the element. An aeration grid below the element provides scouring bubbles.

International Publication No. WO01/36075 describes modules of membranes arranged to substantially cover the cross-sectional area of a tank. In a batch process, the tank is deconcentrated by flowing water upwards through the modules and out through an overflow at the top of the tank.

### SUMMARY OF THE INVENTION

It is an object of the invention to provide an apparatus and method for treating water. It is another object of the invention to provide a membrane separation device and process. The following summary is intended to introduce the reader to the invention and not to define the invention, which may reside in a sub-combination of the following features or in a combination involving features described in other parts of this document.

In a membrane filtration system operated under a batch process, there are three significant flows or functions to be considered. These are (a) the flow of permeate to the headers during the concentration step, (b) the flow of scouring air to the lumens during either the concentration or deconcentration steps, and (c) the flow of concentrated water out of the modules and fresh feed water into the modules during the deconcentration step. A flow of permeate periodically backwashed through the fibers is also typically present. However, this flow is typically timed to coincide with the deconcentration step and may generally be considered part of it.

In prior art systems, the requirements of these flows often interfere with each other. For example, in the system of International Publication No. WO 98/28066, the flow of scouring bubbles and permeate occur in the same direction in the same space. As a result, holes for scouring bubbles are required in the lower header which reduce the number of hollow fibers that can be potted in the headers. Further, the top header is required to withdraw permeate which interferes with the flow of scouring air upwards through the module and encourages the bubbles to flow out of the module rather than rise all the way through it. Together, these factors also constrain the permissible depth of the module because of the pressure drop caused by flow through the hollow fiber membrane. In the system of International Publication No. WO01/36074, the direction of permeate flow is in the same space as, but perpendicular to, the flow of scouring air. This allows permeate to be withdrawn from both headers, if desired, without using complex headers, reduces air scouring as a factor effecting choice of membrane length, removes the headers from the flow path of scouring air and allows the scouring bubbles to be contained in vertical flow channels so that they do not flow out of the module. However, the flow of tank side water during deconcentration is in the same direction and space as the scouring air. While the system is still satisfactory, this creates competing objectives. In particular, to maximize the speed or efficiency of tank water flow during deconcentration, and reduce the stress caused by this flow on the fibers, it is desirable to leave some passage through the vertical flow cannels, for example by potting slackened fibers in bundles pulled together at the headers. However, scouring air bubbles are also inclined to flow through these passages which decreases their effectiveness and may create undesirable local high velocity water flows by air lift effect during air scouring. Accordingly, the passages cannot be made too large. Further, although slackened fibers respond better to air scouring, the slackened fibers are also pulled into the passages by the deconcentration flows, decreasing the effective size of the passages. Accordingly, the fibers may still be exposed to deconcentration flows at high velocity, for example in the range of 4 to 10 cm/s, which may stress the fibers, limit allowable fiber length or require the use of a strong, typically expensive, fiber.

In the current invention, the three flows do not occupy the same space while flowing in the same direction. All three flows must pass through the membrane area but, where they do, they are primarily in mutually orthogonal directions. In particular, the permeate flows generally horizontally along the length of fiber membranes. Deconcentration flows of feed or tank water through the membrane area also have a significant horizontal component, but are generally perpendicular to the fibers, until they clear the membrane area. The flow of scouring bubbles is vertical through the membrane area. These flows are facilitated, according to one aspect of the invention, by providing groups of horizontally oriented hollow fiber membranes in areas, for example in horizontally compressed, vertically oriented generally rectangular fiber areas, separated by vertical deconcentration passages or gaps. The gaps provide a less resistive path for vertical water flow than through the membrane area. An optional plate below or integrated with the aerator across the bottom of the fiber area may inhibit deconcentration flows from traveling vertically through the fiber area. Flow through shrouds or panels separate the fiber area from the gaps. However, the shrouds allow deconcentration flows to travel vertically through the passages, but horizontally, or partially horizontally, through the shrouds into or out of the fiber area. In this way, the effect of these flows on each other are reduced. In particular, the fibers can be packed uniformly across the entire fiber area. This, combined with a reduction in air lift effects through passages in the fiber area, encourages a more even distribution of scouring bubbles both horizontally and vertically and reduces unintended local high velocity flows of water by air lift during air scouring. Further, water velocities during deconcentration for a deep module or stack of modules can be reduced by a factor of 4 to 50, or to 1 cm/s or less. This reduces stress on the fibers and allows a wider range of fiber lengths, or strengths to be used. The average distance that solids travel through the fiber area during deconcentration is also reduced, for example to about 10 cm or less, regardless of the height of the module or stack of modules. Resistance to flow out of the tank during deconcentration is also reduced. Deconcentration may still be performed by overflow or tank draining.

In other aspects, the invention relates to the design of various elements or modules, including various shrouds or headers for separating the fiber area from the deconcentration channels. The invention also relates to means for encouraging scouring air bubbles to flow through the fiber area in tall modules or stacks of modules, for example by using horizontal air collecting plates or features of the shrouds. Other aspects of the invention are described in the following description of embodiments or in the claims.

### BRIEF DESCRIPTION OF THE DRAWINGS

Preferred embodiments of the present invention will now be described with reference to the following figures.

FIG. 1A is a side view of an element with the shroud removed from the near side.

FIG. 1B is a side view of a module, with the near side of a frame removed, using elements of FIG. 1A.

FIG. 1C is a top view of the module of 1B.

FIG. 2A is a side view of another element with the shroud removed from the near side.

FIG. 2B is a side view of another module with the near side of a frame removed using elements of FIG. 2A.

FIG. 2C is a top view of the module of 2B.

FIG. 3 is a sectioned view of an element while a tank is being drained.

FIGS. 4A and 4B are side views of alternate shrouds.

FIG. 5 is a side view of an alternate module with the near side of the frame removed.

### DETAILED DESCRIPTION OF EMBODIMENTS

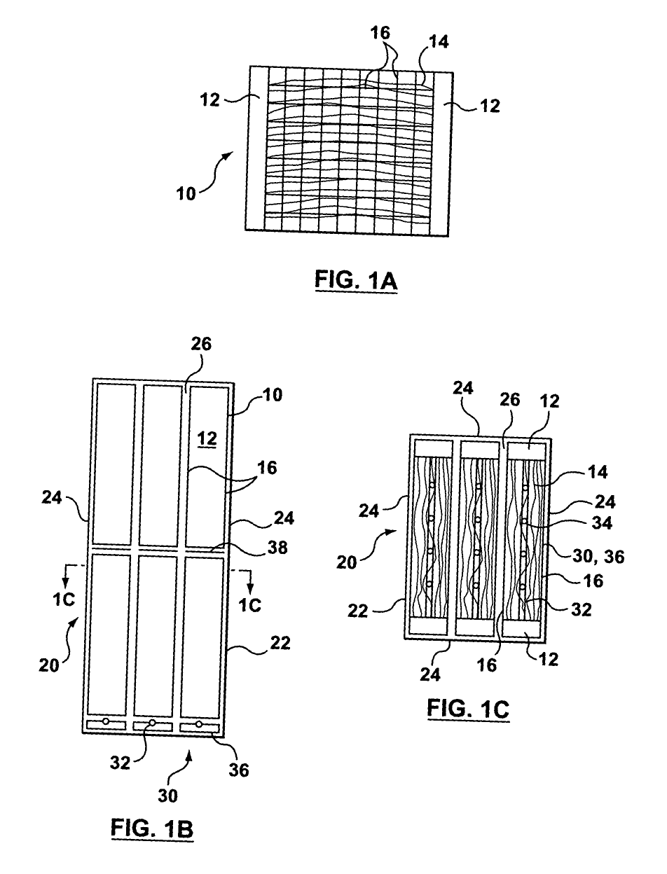

FIGS. 1A, 1B, and 1C show a first embodiment. An element 10 has a pair of vertically oriented headers 12. The headers 12 are generally parallel to each other and horizontally spaced apart. One or both headers 12 may have permeate channels communicating with the lumens of hollow fiber membranes 14 spanning between the headers. A pair of shrouds 16 also extend between the headers 12 and define a fiber area bounded by the inside surfaces of the headers 12 and shrouds 16. The fiber area is open at the top and bottom to permit water to flow vertically through it. The fibers 14 are mounted in a slackened state but the shrouds 16 prevent them from leaving the fiber area. The shrouds 16 are made of a plastic mesh, however, and so water can move horizontally through the shrouds 16.

In a module 20, the elements 10 are stacked on top of each other, for example in stack 1 to 4 elements 10 high, with the fiber areas vertically aligned. Multiple stacks of elements 10 are placed side by side in rows so as to have adjacent shrouds 16. The rows may be, for example, between 1 and 40 stacks of elements 10 wide. If desired, additional rows may also be added so as to have adjacent headers 12. A frame 22 holds the elements 10 in position and also provides walls 24, which may be solid, on all 4 sides of the module. However, the frame 22 is open at its top and bottom to permit water to flow vertically through the elements 10.

The fiber areas of the elements 10 are horizontally spaced apart in the rows by gaps 26. The gaps 26 provide a vertical passage through the module 20 along the outsides of the shrouds 16 of the elements 10. For headers between 5 and 20 cm wide, the gaps 26 may be between 0.5 and 2 cm wide.

The modules 20 also have aerators 30. The aerators 30 have an aerator tube 32 with holes 34 for discharging scouring bubbles. The aerators 30 may also have optional solid plates 36 which extend horizontally below the fiber area. The solid plates 36 generally cover the area of the fiber area projected downwards onto a horizontal plane below the fiber area. The modules 20 may also optionally have re-aeration plates 38 between elements 10 in a vertical stack. The re-aeration plates 38 have holes through them and extend generally across the area of the fiber area of an upper element 10 projected downwards onto a plane containing the re-aeration plates 38. The solid plates 36 inhibit tank water from rising rapidly or unevenly in an air lift effect while scouring bubbles are provided. The re-aeration plates 38 perform a similar function. The re-aeration plates 38 may have a concave downward, or other downward opening shape, and holes along a central line or dispersed across their width. In this way, the re-aeration plates 38 may collect scouring bubbles that have moved to the sides of a lower element 10 and re-release them in the middle of or spread across an upper element 10. This counteracts any tendency of the bubbles to move horizontally out of the elements 10 and into the gaps 26. The solid plates 36 and re-aeration plates 38 also slow the vertical movement of water through the elements 10 during a deconcentration. As will be explained further below, this encourages tank water to flow more nearly horizontally into our out of the elements 10 during deconcentrations.

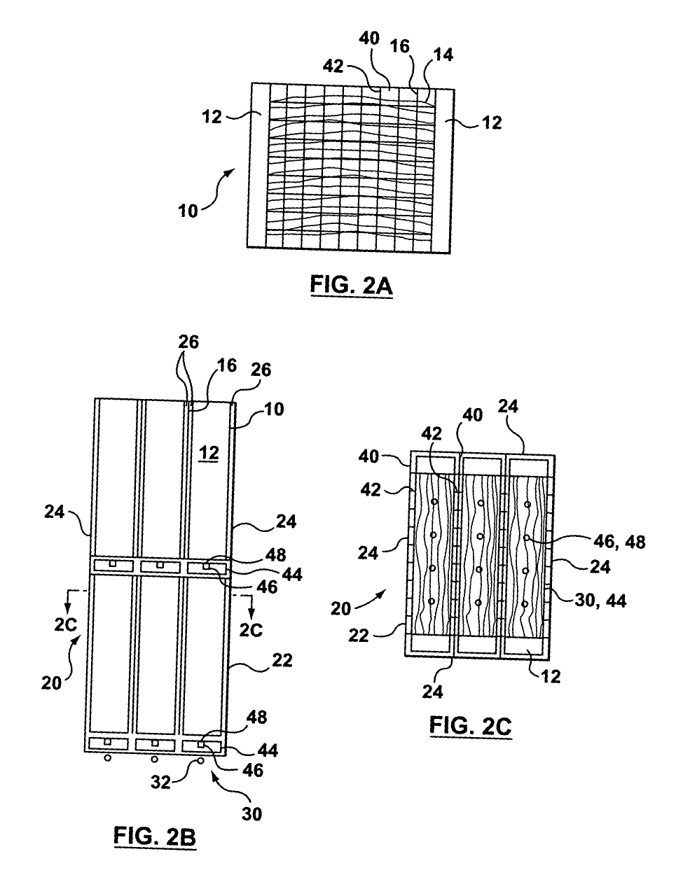

FIGS. 2A, 2B and 2C describe a second embodiment. The second embodiment is generally similar to the first. However, various differences between the embodiments will be described below. The shrouds 16 of the second embodiment have a solid flat plate 40 and vertical ribs 42. The shroud 16 is installed at a slight spacing horizontally from the fiber area. However, the ribs 42 extend inwards towards the fiber area. The edges of the ribs 42 furthest from the plate 40 contact the fibers 14 and so restrain the fibers 14 in the fiber area. The spaces between the sides of the ribs 42, the inside surface of the plate 40 and the fibers 14 provides the gaps 26. Because these gaps 26 serve only a single stack of elements 10, they may be about one half of the width of the gaps 26 of the first embodiment. Between adjacent stacks of elements 10, a single shroud 16 having ribs 42 on both sides of a plate 40 may be used. At the end of a row of elements 10, the wall 24 of the frame 22 may have ribs 42 and the shrouds 16 omitted.

The second embodiment also has an alternate aerator 30. This aerator 30 has an aerator tube 32 below an inverted air box 44. The air box 44 has 4 sides and a top but no bottom. The top of the air box 44 has short air tubes 46 protruding part way downwards into the air box 44 and communicating with holes 48 in the top of the air box 44. Bubbles released from the aerator tube 32 flow upwards and collect under the top of the air box 44 and form a cushion of air extending to the bottom of the tubes 46. When further bubbles are added, the cushion of air overflows into the tubes 46 and bubbles are produced out of the holes 48. The cushion of air permits a rapid dispersion of air to all of the tubes 46 and an even flow of bubbles through the holes 48. Further air boxes 44 may be provided between elements 10 in a vertical stack. The air boxes 44 perform the functions of the solid plates 36 and re-aeration plates 38 of the first embodiment.

Although the elements 10 or modules 20 could be used in other processes, they are particularly suited for use in a batch filtration process. A batch filtration process is described generally in the Background of the Invention part of this document. As discussed in that section, a batch process includes a deconcentration step in which water in the tank with a high solids concentration is removed and replaced with feed water having a lower solids concentration. Scouring bubbles are typically provided just before or during this step to loosen solids from the fibers 14 themselves. During the deconcentration step, water containing these solids must flow out of the elements 10 or modules 20 to carry the solids away from the fibers 14.

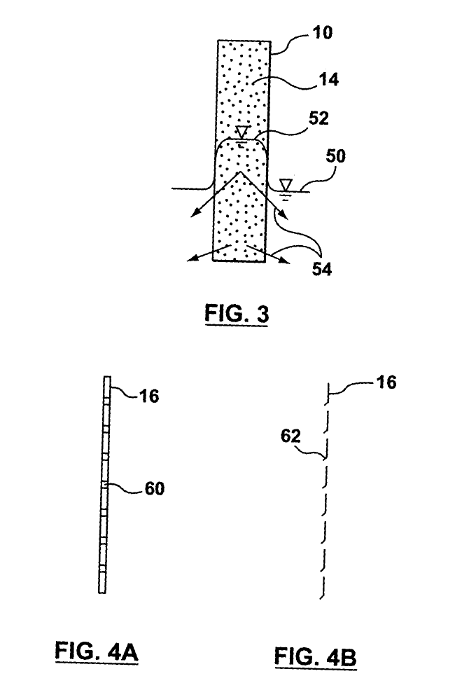

In FIG. 3, a tank containing an element 10 is being deconcentrated by draining the tank. As the tank drains, the tank water level 50 drops. The tank water level 50 is the level of tank water, or retentate, outside of the fiber area, for example in the gaps 26 on either side of the element 10. However, an element water level 52 drops less rapidly because the fibers 14 provide resistance to the flow of tank water out of the element 10. The difference between the element water level 52 and tank water level 50 creates a pressure gradient that generates an element-tank flow 54 with a horizontal component out of the fiber area. In this way, tank water flows partially or generally horizontally out of the element 10 rather than vertically to the bottom of the fiber area or to an element 10 below, if any. As a result, most of the water flowing out of the element 10 flows through the fiber area for a few cm, for example up to about 80% of the width of the element 10 accounting for partially diagonal flow, until it reaches a clear area, such as the gaps 26. Solid plates 36, re-aeration plates 38 or air boxes 44, if used, enhance the horizontal flow by providing additional resistance to vertical flow through the elements 10. A similar process occurs in reverse as the tank is re-filled. During re-fill, the tank water level 50 rises faster than the element water level 52 causing a partially or generally horizontal flow of feed water into the element 10.

The elements 10 and modules 20 may also be used in processes where the tank is deconcentrated by a rapid flush or by overflowing tank water from the top of the tank. In these cases, the membranes 14 are backwashed during the deconcentration. The backwash creates a flow of water carrying solids from the elements 10 to the gaps 26. The flushing or overflow water flows in the gaps 26 and carries the solids out of the tank.

FIGS. 4A and 4B show alternate shrouds 16 for a module 20 of the first embodiment which assist in keeping the scouring bubbles out of the gaps 26, particularly in a tall element 10 or stack of elements 10. In FIG. 4A, the shroud 16 is a plate having a grid of holes 60. The holes 60 allow tank or feed water to flow horizontally through them during deconcentration but scouring bubbles, which rise generally vertically, still see the shroud 16 as a barrier. In FIG. 4B, the shroud 16 has a plurality of louvers 62 which similarly allow tank or feed water to flow through them but inhibit the flow of scouring bubbles out of the element 10.

The embodiments described above are exemplary only. Other or modified devices and processes may also be within the scope of the invention which is defined by the following claims.

1. A module for batch filtration of water wherein the flow or permeate through the lumens of hollow fiber membranes, the rise of scouring bubbles and the flow of tank water through he fibers during deconcentration, all occur in different directions.

2. A module of filtrating membranes having a plurality of elements, each element having membranes oriented generally horizontally between opposed pairs of vertically extending headers and shroud plates extending between the sides of the headers, the shrouds restraining the membranes in a membrane area, the module having vertical gaps between adjacent membrane areas, the shrouds permitting water to flow through them into or out of the membrane areas.

3. The module of claim 2 wherein the shroud inhibits scouring bubbles from flowing from the membrane areas to the gaps.

4. A process of filtering water comprising using a module according to claim 1 in a batch filtration process.

5. The process of claim 4 wherein the module is backwashed while it is deconcentrated.

6. A process of filtering water comprising using a module according to claim 2 in a batch filtration process.

7. The process of claim 6 wherein the module is backwashed while it is deconcentrated.
